(19) United States
(12) Patent Application Publication
(10) Pub. No.: US 2007/0071505 A1
(43) Pub. Date: Mar. 29, 2007

(54) Hybrid development apparatus and development method therefor

(75) Inventor: Ki-jae Do, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/526,795

(22) Filed: Sep. 26, 2006

(30) Foreign Application Priority Data
Sep. 26, 2005 (KR) 2005-0089510

(51) Int. Cl. G03G 15/09

(52) U.S. Cl. 399/270; 399/272; 399/273

(57) ABSTRACT

A hybrid development apparatus and a development method therefor are provided. The hybrid development apparatus includes a magnetic roller, a donor roller, and a collecting roller. A supply bias voltage, a development bias voltage, and a collecting bias voltage are respectively applied to the three rollers. The three bias voltages are tri-level bias voltages having same voltage duties of maximum, medium and minimum voltages and phases thereof are different by 120 degrees from each other.

### CROSS-REFERENCE TO RELATED PATENT APPLICATION

This application claims the benefit under 35 U.S.C. § 119(a) of Korean Patent Application No. 10-2005-0089510, filed on Sep. 26, 2005, in the Korean Intellectual Property Office, the entire disclosure of which is hereby incorporated by reference.

### BACKGROUND OF THE INVENTION

1. Field of the Invention

The present invention relates to an electrophotographic development apparatus and a development method therefor. More particularly, the present invention relates to a hybrid development apparatus using a magnetic carrier and a non-magnetic toner and a development method therefor.

2. Description of the Related Art

Development methods for image-forming apparatuses using an electrophotographic technique such as copy machines, printers, facsimiles, and multifunction machines are roughly classified into a two-component development method, a one-component development method, and a hybrid development method. In the two-component development method, a toner and a magnetic carrier are used. In the one-component development method, an insulating toner or a conductive toner is used. In the hybrid development method, a non-magnetic toner is charged using a magnetic carrier, only charged toners are attached onto a development roller, and the charged toners on the development roller are transferred onto an electrostatic latent image formed on an image receptor and develop the electrostatic latent image.

The two-component development method has advantages of having good charging properties of the toner. In addition, the lifetime of the toner can be prolonged, and an image can be uniformly obtained. On the other hand, a development apparatus using this method is large and complex, and there are problems of dispersion of a toner, attachment of a carrier onto a latent image, and deterioration in durability of a carrier.

In the one-component development method, the development apparatus is compact and dot-reproducibility thereof is excellent. However, there are problems in that durability is low due to deterioration in the quality of a development roller and a charging roller, the price of consumable parts is high because the entire development apparatus must be replaced when the toner is used up, and a selective development is carried out. During the selective development, a toner having a predetermined weight and electric charge is attached from the development roller to the electrostatic latent image. If the selective development is continuously carried out, a toner having less than the predetermined weight and electric charge cannot be used in a development process, which leads to a decrease in a toner usage rate.

In the hybrid development method, the dot-reproducibility is excellent, the lifetime of the apparatus can be prolonged, and a high speed image forming can be obtained. However, if insufficient amount of toners are supplied to the development roller or toners remaining on the development roller after a development is not sufficiently removed, a development ghost can occur. A mechanism by which of the development ghost occurs will now be described with reference to FIG. 1. Referring to FIG. 1(a), in a toner layer formed on the surface of the development roller, a toner in an area Ai facing an image portion of an image receptor is developed onto the image receptor in response to the development bias voltage, while a toner in an area Ab facing a non-image portion is not developed but remains on the surface of the development roller. Here, the amount of the toner developed from the area Ai to the image receptor is referred to as Ma. For a next development, a new toner is supplied to the development roller. If the amount of the toner supplied to the development roller is less than Ma, as shown in FIG. 1(b), the thickness of the toner layer formed on the surface of the development roller is not uniform, which leads to a development ghost since a latent image of the previous development remains in the next development process. The development ghost occurs more frequently when printing is continuously performed.

Accordingly, there is a need for an improved hybrid development apparatus and method that prevents development ghost during printing.

### SUMMARY OF THE INVENTION

An aspect of exemplary embodiments of the present invention is to address at least the above problems and/or disadvantages and to provide at least the advantages described below. Accordingly, an aspect of exemplary embodiments of the present invention is to provide a simple hybrid development apparatus that can prevent formation of a development ghost, print an image uniformly when printing is continuously performed, and stably print high quality images, and a development method therefor.

According to an aspect of exemplary embodiments of the present invention, there is provided a hybrid development apparatus which forms a magnetic brush of non-magnetic toner and magnetic carriers on the outer circumference of a magnetic roller, supplies the non-magnetic toner to a donor roller, and develops the toner onto an image receptor. The hybrid development apparatus includes a collecting roller which faces the donor roller and the magnetic roller and is disposed on a downstream side of a development area where the donor roller and the image receptor face each other, with respect to the direction of rotation of the donor roller; and a power supply which supplies a supply bias voltage, a development bias voltage, and a collecting bias voltage to the magnetic roller, the donor roller, and the collecting roller, respectively. The supply bias voltage, the development bias voltage, and the collecting bias voltage are tri-level bias voltages having the same voltage duties of the maximum, medium, and minimum voltages, and the phases of the supply bias voltage, the development bias voltage, and the collecting bias voltage are different by 120 degrees in this order.

According to another aspect of exemplary embodiments of the present invention, there is provided a hybrid development method, in which a donor roller is provided which faces an image receptor, a magnetic roller is provided which forms a magnetic brush of a non-magnetic toner and a magnetic carrier on the outer circumference thereof by a magnetic force and is disposed on an upstream side of a development area where the donor roller and the image receptor face each other, with respect to the direction of rotation of the donor roller, and a collecting roller is provided which faces the donor roller and the magnetic roller and is disposed on a downstream of the development area with respect to the direction of rotation of the donor roller. A supply electric field is formed that transfers a toner from the magnetic roller to the development roller in a supply area where the magnetic roller and the donor roller face each other, a development electric field is formed that develops the toner from the donor roller to an electrostatic latent image on the image receptor in the development area, a first electric field is formed that transfers the toner from the donor roller to the collecting roller in a first collecting area where the donor roller and the collecting roller face each other, and a second collecting electric field is formed that transfers the toner from the collecting roller to the magnetic roller in a second collecting area where the collecting roller and the magnetic roller face each other, by applying a supply bias voltage, a development bias voltage, and a collecting bias voltage to the magnetic roller, the donor roller, and the collecting roller, respectively.

According to another aspect of exemplary embodiments of the present invention, there is provided a hybrid development method for a hybrid development apparatus having a donor roller which faces an image receptor, a magnetic roller which forms a magnetic brush of a non-magnetic toner and a magnetic carrier on the outer circumference thereof by a magnetic force and is disposed on an upstream side of a development area where the donor roller and the image receptor face each other, with respect to the direction of rotation of the donor roller, and a collecting roller which is disposed on a downstream side of the development area with respect to the direction of rotation of the donor roller. The hybrid development method includes the collecting roller disposed in opposite to the donor roller and the magnetic roller; the non-magnetic toner supplied from the magnetic roller to the donor roller; and toner remaining on the donor roller collected after passing through the development area among the toner supplied to the donor roller, onto the magnetic roller via the collecting roller.

In the aforementioned aspect of exemplary embodiments of the present invention, the collecting roller may come in contact with the donor roller.

In an exemplary implementation, the collecting roller may rotate in a forward direction with respect to the donor roller.

In another exemplary implementation, the minimum, medium, and maximum voltages of the supply bias voltage, the development bias voltage, and the collecting bias voltage may be the same.

In still another exemplary implementation, the maximum, medium, and minimum voltages of the supply bias voltage, the development bias voltage, and the collecting bias voltage are determined such that a voltage difference of a reverse electric field formed on the development area, a first collecting area where the donor roller and the collecting roller face each other, and a second collecting area where the collecting roller and the magnetic roller face each other is less than a threshold electric potential difference, at which the toner is transferred, in the development area and the first and second collecting areas.

Other objects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other objects, features and advantages of certain exemplary embodiments of the present invention will be more apparent from the following description taken in conjunction with the accompanying drawings in which:

FIGS. 1(a) and 1(b) are views illustrating a development ghost generation process;

FIG. 2 is a view of a structure of a development apparatus according to an exemplary embodiment of the present invention;

FIG. 3 is a view illustrating an example of a supply bias voltage, a development bias voltage, and a collecting bias voltage for a negatively charged toner;

FIG. 4 is a view illustrating a toner transfer process according to the development apparatus of an exemplary embodiment of the present invention;

FIG. 5 is a view illustrating an electric field in a supply area and the toner transfer process;

FIG. 6 is a view illustrating an electric field in a first collecting area and the toner transfer process;

FIG. 7 is a view illustrating an electric field in a second collecting area and the toner transfer process;

FIGS. 8(a)-8(c) are views illustrating a change in a toner layer on the surface of a donor roller; and

FIG. 9 is a view illustrating an example of a supply bias voltage, a development bias voltage, and a collecting bias voltage for a positively charged toner.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

FIG. 2 is a schematic view of a structure of a hybrid development apparatus according to an exemplary embodiment of the present invention. Referring to FIG. 2, the hybrid development apparatus includes an image receptor 10, a donor roller 1, a magnetic roller 2, and a collecting roller 3. In an exemplary implementation, an organic photosensitive conductor is used as the image receptor 10. Also, an amorphous silicon photosensitive conductor may be used as the image receptor 10. In order to form an electrostatic latent image on the image receptor 10, a charging unit 21 and an exposure unit 22 are used. A corona charger or a charging roller may be used as the charging unit 21. A laser scanning unit (LSU) for illuminating a laser beam may be used as the exposure unit 22. In addition, an electrostatic drum (not shown) may be used as the image receptor 10. In this case, in order to form the electrostatic latent image, an electrostatic recording head (not shown) may be used instead of the exposure unit 22.

A developer 6 stores a non-magnetic toner and a magnetic carrier. The carrier is a magnetic powder type. The stirrer 4 stirs the carrier and the toner to frictionally charge the toner. The toner is not particularly limited, and either a negative or positive charged toner is acceptable.

The donor roller 1 faces the image receptor 10. In case of a contact type development apparatus, the donor roller 1 comes in contact with the image receptor 10 by applying predetermined pressure, whereas in case of a non-contact type development apparatus, the donor roller 1 is separated from the image receptor 10 by a development gap G. The development gap G is approximately 150 to 400 μm, preferably 200 to 300 μm. If the development gap G is less than 150 μm, image fading occurs, and if the development gap G is greater than 400 μm, the toner cannot be readily transferred to the image receptor 10, and thus a sufficient image density cannot be obtained, which leads to a selective development.

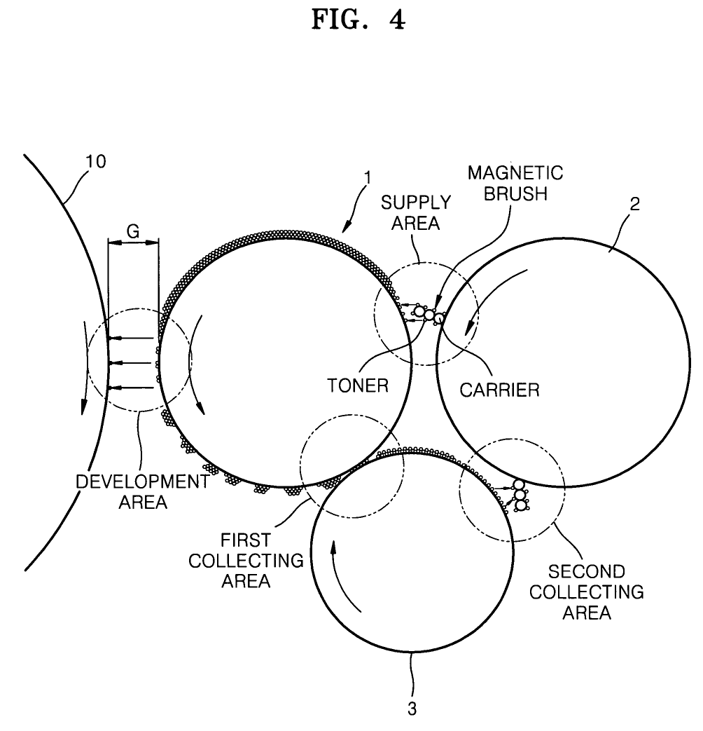

The magnetic roller 2 is disposed on an upstream side of a development area where the donor roller 1 and the image receptor 10 face each other, with respect to the direction of rotation of the donor roller 1. Although not shown, the magnetic roller 2 includes a rotating sleeve and a magnet disposed in the sleeve. The surface roughness of the sleeve is approximately 3 to 9 μm. The carrier is attached to the outer circumference of the magnetic roller 2 by the magnetic force of the magnet, and the toner is attached to the carrier by the electrostatic force. Then, a magnetic brush (see FIG. 4) having the carrier and the toner is formed on the outer circumference of the magnetic roller 2. A trimmer 5 controls the magnetic brush to have a uniform thickness. The distance between the trimmer 5 and the magnetic roller 2 is preferably 0.3 to 1.5 mm. The distance between the magnetic roller 2 and the donor roller 1 is approximately 0.3 to 1.5 mm.

A power supply 30 applies a supply bias voltage V1 to the magnetic roller 2 for supplying the toner onto the donor roller 1 and a development bias voltage V2 to the donor roller 1 for developing the toner onto the image receptor 10. The toner is transferred from the magnetic roller 2 to the donor roller 1 in response to the supply bias voltage V1, and a toner layer is formed on the outer circumference of the donor roller 1. While passing the development area, the toner is attached onto the electrostatic latent image formed on the image receptor 10, and a toner image is formed on the image receptor 10. The toner image is transferred onto a paper P passing a transfer nip where a transfer unit 23 and the image receptor 10 face each other, and is fixed onto the paper P by heat and pressure 25. Thereby, printing is completed. A cleaning blade 24 removes a toner remaining on the image receptor 10 after the transfer of toner is terminated.

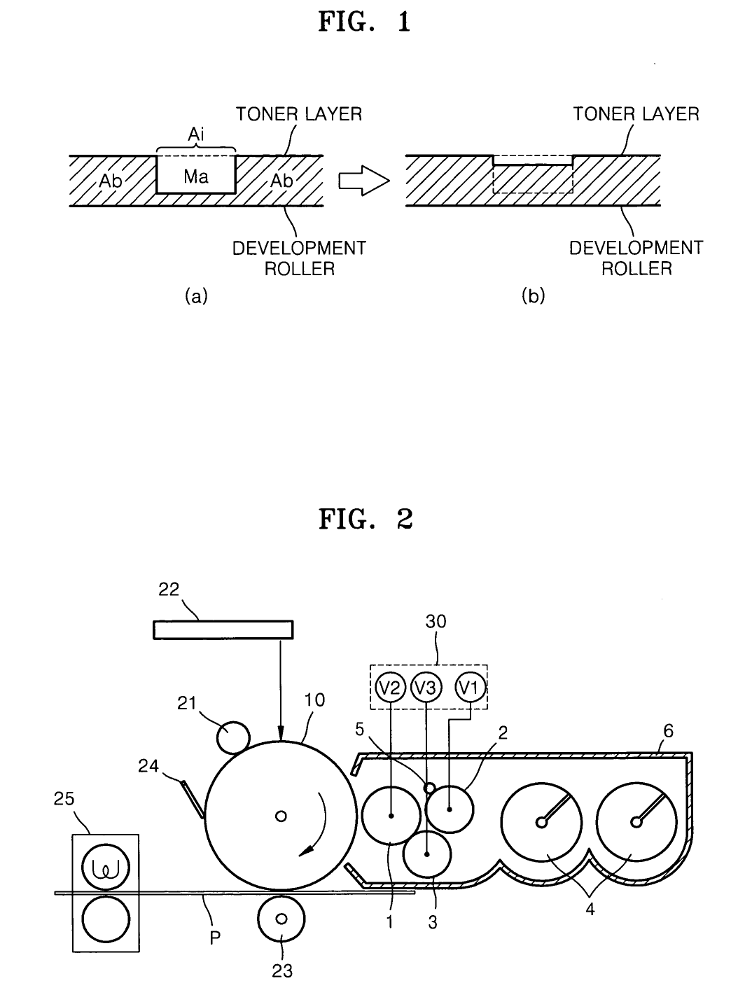

As shown in FIG. 1, after passing the development area, the thickness of the toner layer on the surface of the donor roller 1 is not uniform. If the toner is supplied again to the donor roller 1 in this condition, the toner layer cannot be uniformly formed, thereby causing the development ghost. The development apparatus of an exemplary embodiment of the present includes the collecting roller 3 which collects the toner remaining on the donor roller 1 after developing. The collecting roller 3 is disposed on a downstream side of the development area with respect to the direction of rotation of the donor roller 1. The gap between the collecting roller 3 and the magnetic roller 2 can be the same as the gap between the magnetic roller 2 and the donor roller 1. The power supply 30 applies a collecting bias voltage V3 to the collecting roller 3 for collecting the toner from the donor roller 1.

Where the toner is simply collected from the donor roller 1 to the collecting roller 3, for example, in case of a negatively charged toner, the relationship among the collecting bias voltage V3, the development bias voltage V2, and the supply bias voltage V1 may be V3>V2>V1. In case of a positively charged toner, the relationship may be V3<V2<V1. However, in this case, since the collected toner may be continuously attached onto the collecting roller 3, the capability of collecting toner via the collecting roller 3 and the collecting bias voltage V3 may deteriorate. In addition, the toner attached onto the collecting roller 3 may be attached again onto the donor roller 1.

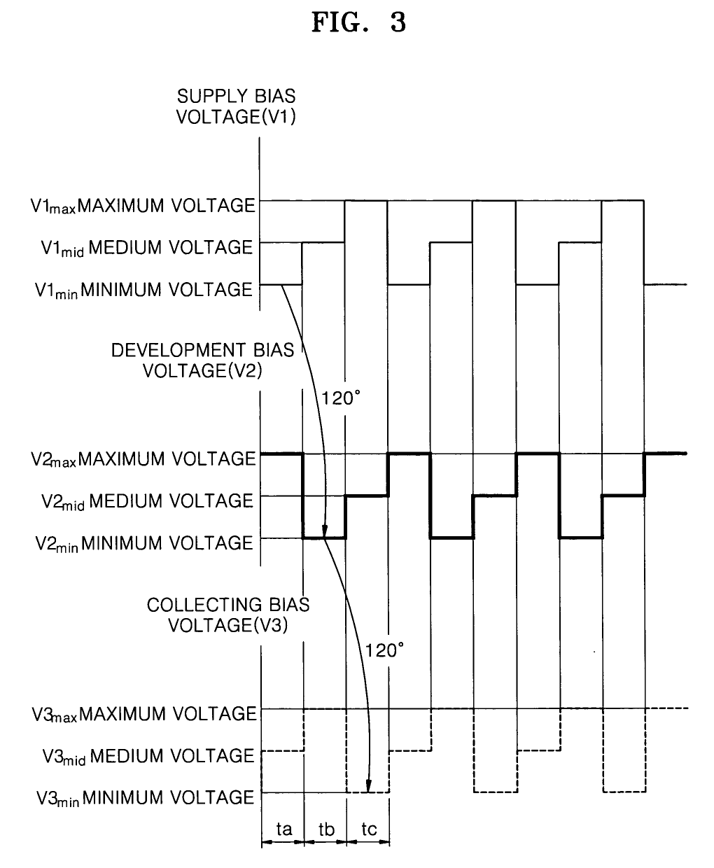

In the development apparatus according to an exemplary embodiment of the present invention, the toner on the donor roller 1 is collected onto the collecting roller 3, and also the collected toner is transferred onto the magnetic roller 2 again. As shown in FIG. 3, tri-level bias voltages having maximum voltages V1max, V2max and V3manx, medium voltages V1mid, V2mid and V3mid, and minimum voltages V1min, V2min and V3min are used as the supply bias voltage V1, the development bias voltage V2, and the collecting bias voltage V3, respectively. Voltage duties of the maximum, medium, and minimum voltages are the same. This means that times ta, tb and tc for applying the maximum voltages V1max, V2max and V3manx, the medium voltages V1mid, V2mid and V3mid, and the minimum voltages Vmin, V2min and V3min are the same. Phases of the supply bias voltage V1, the development bias voltage V2, and the collecting bias voltage V3 are different from each other by 120 degrees in this order. FIG. 3 illustrates the supply bias voltage V1, the development bias voltage V2, and the collecting bias voltage V3 for a negatively charged toner. FIG. 9 illustrates the supply bias voltage V1, the development bias voltage V2, and the collecting bias voltage V3 for a positively charged toner.

According to an exemplary embodiment of the present invention, operations of a development method for the aforementioned development apparatus are as follows. Hereinafter, it is assumed that the toner is negatively charged.

The magnetic roller 2, the donor roller 1, and the collecting roller 3 face each other as shown in FIG. 4. In an exemplary implementation, the magnetic roller 2 is slightly separated from the donor roller 1, and the collecting roller 3 comes in contact with the donor roller 1. Although the material of the collecting roller 3 is not particular limited, the surface layer of the collecting roller 3 is preferably made of an elastic rubber layer if the collecting roller 3 comes in contact with the donor roller 1.

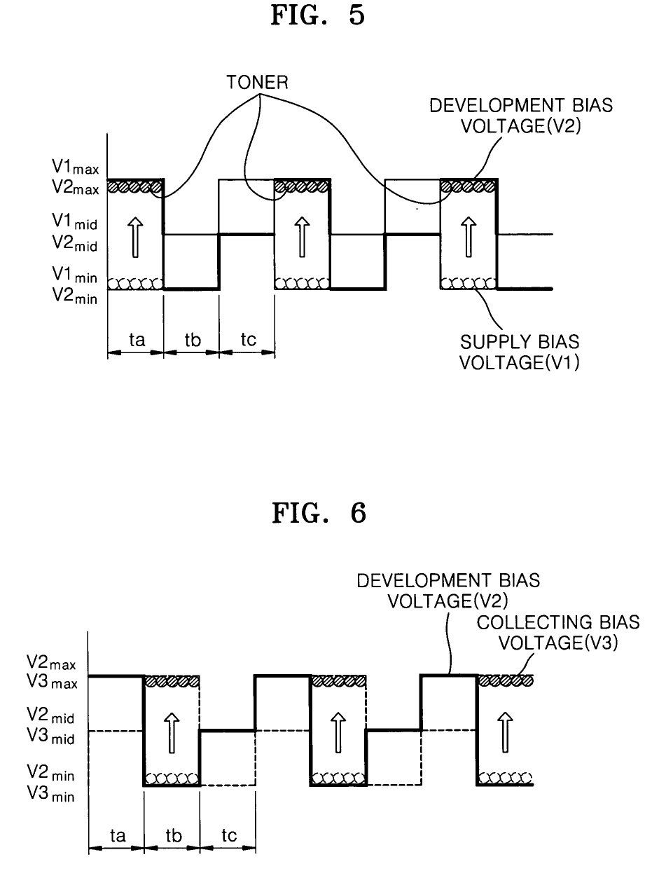

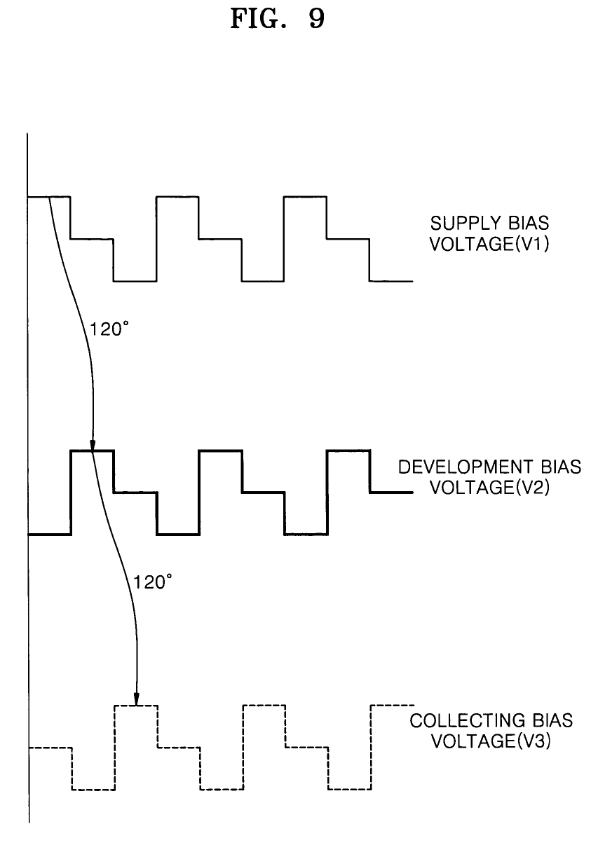

In an area where the magnetic roller 2 and the donor roller 1 face each other, as shown in FIG. 5, a supply electric field is created by the supply bias voltage V1 and the development bias voltage V2. The phase of development bias voltage V2 lags with respect to that of the supply bias voltage V1 by 120 degrees. As a result, the donor roller 1 and the magnetic roller 2 receive the maximum voltage V2max of the development bias voltage V2 and the minimum voltage V1min of the supply bias voltage V1 during time ta, the minimum voltage V2min of the development bias voltage V2 and the medium voltage V1mid of the supply bias voltage V1 during time tb, and the medium voltage V2mid of the development bias voltage V2 and the maximum voltage V1max of the supply bias voltage V1 during time tc. During time ta, the electric field is directed in the direction in which the toner is transferred from the magnetic roller 2 to the donor roller 1. During times tb and tc, the electric field is directed in the direction in which the toner is transferred from the donor roller 1 to the magnetic roller 2. Since the intensity of the supply electric field during time ta is greater than the intensity of the reverse electric field during times tb and tc, as a whole, the toner is transferred from the magnetic roller 2 to the donor roller 1. Thus, a uniform toner layer is formed on the surface of the donor roller 1 as shown in FIG. 8(a).

A development electric field created by electric potentials of the image and non-image portions of the image receptor 10 acts on the development area. In the case of the negatively charged toner, the electric potential in the image portion is greater than the electric potential in the non-image portion. According to the development electric field, the toner passes across the development gap G, is developed onto the image portion of the electrostatic latent image formed on the image receptor 10, and the toner image is formed onto the image receptor 10. The toner layer on the surface of the donor roller 1 facing a first collecting area where the donor roller 1 and the collecting roller 3 face each other is not uniform as shown in FIG. 8(b).

In the first collecting area, as shown in FIG. 6, a first collecting electric field that transfers the toner from the donor roller 1 to the collecting roller 3 is created by the development bias voltage V2 and the collecting bias voltage V3. Phase of the collecting bias voltage V3 lags with respect to the phase of the development bias voltage V2 by 120 degrees. As a result, the donor roller 1 and the collecting roller 3 respectively receive the maximum voltage V2max of the development bias voltage V2 and the medium voltage V3mid of the collecting bias voltage V3 during time ta, the minimum voltage V2min of the development bias voltage V2 and the maximum voltage V3max of the collecting bias voltage V3 during time tb, and the medium voltage V2mid of the development bias voltage V2 and the minimum voltage V3min of the collecting bias voltage V3 during time tc. During time tb, the electric field is directed in the direction in which the toner is transferred from the donor roller 1 to the collecting roller 3. During times ta and tc, the electric field is directed in the direction in which the toner is transferred from the collecting roller 3 to the donor roller 1. Since the intensity of the first collecting electric field during time tb is greater than the intensity of the reverse electric field during times ta and tc, as a whole, the toner remaining on the donor roller 1 after passing through the development area is transferred from the donor roller 1 to the collecting roller 3. Accordingly, the toner on the surface of the donor roller 1 directing to the supply area is almost entirely collected onto the collecting roller 3, or even when the toner remains on the surface of the donor roller 1 as shown in FIG. 8(c), the thickness thereof is uniformly thin. Therefore, if the toner is supplied again to the donor roller 1 in the supply area, a uniform toner layer as shown in FIG. 8 (a) is formed on the surface of the donor roller 1. Thus, the development ghost does not occur in the next development process. If the collecting roller 3 is separated from the donor roller 1, the toner is dispersed in the first collecting area, so that the surface of the donor roller 1 moving to the supply area may be re-contaminated. By contacting the collecting roller 3 with the donor roller 1, the toner can be prevented from dispersing, so that toner collecting capability can be improved.

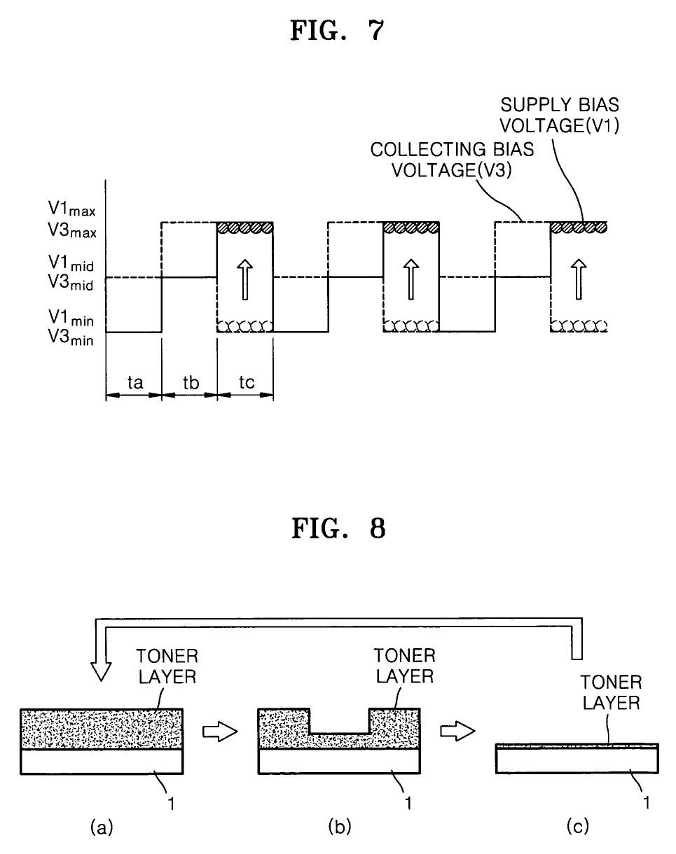

In a second collecting area where the collecting roller 3 and the magnetic roller 2 face each other, as shown in FIG. 7, a second collecting electric field that transfers the toner from the collecting roller 3 to the magnetic roller 2 is created by the collecting bias voltage V3 and the supply bias voltage V1. The phase of the supply bias voltage V1 lags with respect to that of the collecting bias voltage V3 by 120 degrees. As a result, the collecting roller 3 and the magnetic roller 2 respectively receive the medium voltage V3mid of the collecting bias voltage V3 and the minimum voltage V1min of the supply bias voltage V1 during time ta, the maximum voltage V3max of the collecting bias voltage V3 and the medium voltage V1mid of the supply bias voltage V1 during time tb, and the minimum voltage V3min of the collecting bias voltage V3 and the maximum voltage V1max of the supply bias voltage V1 during time tc. During time tc, the electric field is directed in the direction in which the toner is transferred from the collecting roller 3 to the magnetic roller 2. During times ta and tb, the electric field is directed in the direction in which the toner is transferred from the magnetic roller 2 to the collecting roller 3. Since the intensity of the second collecting electric field during time tc is greater than the intensity of the reverse electric field during times ta and tb, as a whole, the toner is transferred from the collecting roller 3 to the magnetic roller 2. Accordingly, since the collecting roller 3 can collect the toner from the donor roller 1 in a clean condition, toner collecting capability can be improved and the collected toner can be prevented from attaching again onto the donor roller 1.

The collecting roller 3 preferably rotates in a forward direction with respect to the donor roller 1. The forward direction refers to the case when the surface of the collecting roller 3 and the surface of the donor roller 1 are transferred in the same direction in the area where the donor roller 1 and the collecting roller 3 face each other. If the collecting roller 3 rotates in a reverse direction with respect to the donor roller 1, the collected toner on the collecting roller 3 may be attached again onto the surface of the donor roller 1 by passing through the first collecting area.

Referring to FIG. 5, the electric field in the supply area during times tb and tc is directed in the direction in which the toner is transferred from the donor roller 1 to the magnetic roller 2. Referring to FIG. 6, the electric field in the first collecting area during times ta and tc is directed in the direction in which the toner is transferred from the collecting roller 3 to the donor roller 1. Referring to FIG. 7, the electric field in the second collecting area during times ta and tb is directed in the direction in which the toner is transferred from the magnetic roller 2 to the collecting roller 3. During the above-mentioned times, a reverse electric field that reversely transfers the toner with respect to a desired direction is formed in the supply area and the first and second collecting areas.

If a potential difference of the reverse electric field is less than a threshold potential difference, the toner is not transferred. Although the potential difference of the reverse electric field is greater than the threshold potential difference, if the difference is substantially small, a movement of the toner by the reverse electric field is also substantially small. The threshold potential difference is determined by various factors such as the charging quantity and mass of the toner, and the resistance and permittivity of each roller. When determining the maximum voltages V1max, V2max and V3max, the medium voltages V1mid, V2mid and V3mid, and the minimum voltages V1min, V2min and V3min of the supply bias voltage V1, the development bias voltage V2, and the collecting bias voltage V3, the difference between the electric potential difference of the reverse electric field and the threshold potential difference is preferably determined to be as small as possible so that the amount of toner transferred during the formation of a reverse electric field can be reduced. More preferably, when determining the maximum voltages V1max, V2max and V3max, the medium voltages V1mid, V2mid and V3mid, and the minimum voltages V1min, V2min and V3min of the supply bias voltage V1, the electric potential difference of the reverse electric field is determined to be smaller than the threshold potential difference so that the toner is not transferred at all when the reverse electric field is created, except for the case of the reversely charged toner. The toner can be effectively transferred in the desired direction in the supply area and the first and second areas.

In an exemplary embodiment of the present invention, a bias voltage, in which the potential difference between the maximum voltage and the minimum voltage is 1.2 KV, frequency is 2.0 KHz, and the potential difference between the minimum voltage and the medium voltage is 0.6 KV, may be transformed to generate the supply bias voltage V1, the development bias voltage V2, and the collecting bias voltage V3 having a phase difference of 120 degrees with respect to each other. The supply bias voltage V1, the development bias voltage V2, and the collecting bias voltage V3 are applied to the magnetic roller 2, the donor roller 1, and the collecting roller 3, respectively. Thus, the power supply 30 may be less expensive if the bias voltages are the same except for their phases, since they can be obtained by changing only their phases using one power source.

Although in the above description, a monochrome development apparatus and a development method therefor have been described, the development apparatus and the development method therefor according to exemplary embodiments of the present invention can be applied to a single-pass type color development apparatus having a tandem configuration and a multi-pass type color development apparatus in which a single image receptor is repeatedly developed and sequentially transferred to a intermediary transfer unit.

Accordingly, a hybrid development apparatus and a development method therefor of the present invention have the following advantages.

First, a toner remaining on a donor roller after developing is collected onto the collecting roller and the collected toner is transferred onto a magnetic roller, so that a development ghost can be prevented from appearing and printing quality is constant during continuous printing.

Second, deterioration of toner collecting capability due to toner dispersion can be prevented by contacting a collecting roller with the donor roller.

Third, the collected toner can be prevented from attaching onto the donor roller by passing through a first collecting area by rotating the collecting roller in a forward direction with respect to the donor roller.

Fourth, a chip power supply can be used since the minimum, medium, and maximum levels, of a supply bias voltage, a development bias voltage, and a collecting bias voltage are the same.

While the present invention has been particularly shown and described with reference to certain exemplary embodiments thereof, it would be understood by those skilled in the art that various changes in form and details may be made therein without departing from the spirit and scope of the present invention as defined by the appended claims and their equivalents.

What is claimed is:

1. A hybrid development apparatus which forms a magnetic brush of non-magnetic toner and magnetic carriers on an outer circumference of a magnetic roller, supplies the non-magnetic toner to a donor roller, and develops the toner onto an image receptor, the hybrid development apparatus comprising:
a collecting roller facing a donor roller and a magnetic roller and is disposed on a downstream side of a development area where the donor roller and an image receptor face each other, in accordance with the direction of rotation of the donor roller; and
a power supply for supplying a supply bias voltage, a development bias voltage and a collecting bias voltage to the magnetic roller, the donor roller and the collecting roller, respectively,
wherein the supply bias voltage, the development bias voltage and the collecting bias voltage are tri-level bias voltages having same voltage duties of maximum, medium and minimum voltages, and phases of the supply bias voltage, the development bias voltage, and the collecting bias voltage are different by 120 degrees.

2. The hybrid development apparatus of claim 1, wherein the collecting roller comes in contact with the donor roller.

3. The hybrid development apparatus of claim 1, wherein the collecting roller rotates in a forward direction in accordance with the donor roller.

4. The hybrid development apparatus of claim 1, wherein the maximum, medium and minimum voltages of the supply bias voltage, the development bias voltage and the collecting bias voltage are the same.

5. A hybrid development method comprising:
providing a donor roller, which faces an image receptor, a magnetic roller which forms a magnetic brush of a non-magnetic toner and a magnetic carrier on an outer circumference thereof by a magnetic force and is disposed on an upstream side of a development area where the donor roller and the image receptor face each other, in accordance with a direction of rotation of the donor roller, and a collecting roller, which faces the donor roller and the magnetic roller and is disposed on a downstream of the development area in accordance with the direction of rotation of the donor roller;
forming a supply electric field that transfers a toner from the magnetic roller to a development roller in a supply area where the magnetic roller and the donor roller face each other, a development electric field that develops the toner from the donor roller to an electrostatic latent image on the image receptor in the development area, a first collecting electric field that transfers the toner from the donor roller to the collecting roller in a first collecting area where the donor roller and the collecting roller face each other, and a second collecting electric field that transfers the toner from the collecting roller to the magnetic roller in a second collecting area where the collecting roller and the magnetic roller face each other, by applying a supply bias voltage, a development bias voltage and a collecting bias voltage to the magnetic roller, the donor roller and the collecting roller, respectively.

6. The hybrid development method of claim 5, wherein the supply bias voltage, the development bias voltage and the collecting bias voltage are tri-level bias voltages having same voltage duties of maximum, medium and minimum voltages, and phases thereof are different by 120 degrees.

7. The hybrid development method of claim 6, wherein the collecting roller comes in contact with the donor roller.

8. The hybrid development method of claim 6, wherein the collecting roller rotates in a forward direction in accordance with the donor roller.

9. The hybrid development method of claim 6, wherein the maximum, medium and minimum voltages of the supply bias voltage, the development bias voltage and the collecting bias voltage are the same.

10. The hybrid development method of claim 6, wherein the maximum, medium, and minimum voltages of the supply bias voltage, the development bias voltage and the collecting bias voltage are determined such that a voltage difference of a reverse electric field, of which electric field is oppositely directed in accordance with the supply electric field, a first collection field, and a second collection field, is less than a threshold electric potential difference, at which the toner is transferred, in the supply area and the first and second collecting areas.

11. A hybrid development method for a hybrid development apparatus having a donor roller which faces an image receptor, a magnetic roller which forms a magnetic brush of a non-magnetic toner and a magnetic carrier on the outer circumference thereof by a magnetic force and is disposed on an upstream side of a development area where the donor roller and the image receptor face each other, in accordance with s direction of rotation of the donor roller, and a collecting roller which is disposed on a downstream of the development area in accordance with the direction of rotation of the donor roller, the hybrid development method comprising:
disposing the collecting roller opposite to the donor roller and the magnetic roller;
supplying the non-magnetic toner from the magnetic roller to the donor roller; and
collecting toner remaining on the donor roller after passing through the development area among toner supplied to the donor roller, onto the magnetic roller via the collecting roller.

12. The hybrid development method of claim 11, wherein the donor roller receives a development bias voltage in a form of a tri-level bias voltage having same voltage duties of the maximum, medium and minimum voltages for developing the toner into an electrostatic latent image on the image receptor,
the magnetic roller receives a supply bias voltage in a form of a tri-level bias voltage having same voltage duties of the maximum, medium, and minimum voltages, and a phase thereof leads in accordance with the phase of the development bias voltage by 120 degrees, and
the collecting roller receives a collecting bias voltage in a form of a tri-level bias voltage having the same voltage duties of the maximum, medium and minimum voltages and the phase thereof lags in accordance with the phase of the development bias voltage by 120 degrees.

13. The hybrid development method of claim 12, wherein the collecting roller comes in contact with the donor roller and rotates in a forward direction in accordance with the donor roller.

14. The hybrid development method of claim 13, wherein the maximum, medium and minimum voltages of the supply bias voltage, the development bias voltage and the collecting bias voltage are the same.

15. The hybrid development method of claim 12, wherein the maximum, medium and minimum voltages of the supply bias voltage, the development bias voltage and the collecting bias voltage are determined such that a voltage difference of a reverse electric field formed on the development area, a first collecting area where the donor roller and the collecting roller face each other, and a second collecting area where the collecting roller and the magnetic roller face each other is less than a threshold electric potential difference, at which the toner is transferred, in the development area and the first and second collecting areas.

16. A hybrid development apparatus, comprising:
an image receptor;
a donor roller facing the image receptor;
a magnetic roller comprising a magnetic brush of non-magnetic toner and magnetic carriers on an outer circumference for supplying the non-magnetic toner to the donor roller and developing toner onto the image receptor;
a collecting roller facing the donor roller and the magnetic roller and disposed on a downstream side of a development area where the donor roller and the image receptor face each other, in accordance with a direction of rotation of the donor roller; and
a power supply for supplying a supply bias voltage, a development bias voltage and a collecting bias voltage to the magnetic roller, the donor roller and the collecting roller, respectively,
wherein the supply bias voltage, the development bias voltage and the collecting bias voltage are tri-level bias voltages comprising same voltage duties of maximum, medium and minimum voltages, and phases of the supply bias voltage, the development bias voltage and the collecting bias voltage are different by 120 degrees.

17. The apparatus of claim 16, further comprising:
a supply electric field created for transferring a toner from the magnetic roller to a development roller in a supply area where the magnetic roller and the donor roller face each other;
a development electric field created for developing the toner from the donor roller to an electrostatic latent image on the image receptor in the development area;
a first collecting electric field created for transferring the toner from the donor roller to the collecting roller in a first collecting area where the donor roller and the collecting roller face each other; and
a second collecting electric field created for transferring the toner from the collecting roller to the magnetic roller in a second collecting area where the collecting roller and the magnetic roller face each other,
wherein the supply electric field, the development electric field, the first collecting electric field and the second collecting electric field are created by applying the supply bias voltage, the development bias voltage and the collecting bias voltage to the magnetic roller, the donor roller and the collecting roller, respectively.

18. The apparatus of claim 16, wherein the collecting roller comes in contact with the donor roller and rotates in a forward direction in accordance with the donor roller.

19. The apparatus of claim 16, wherein the maximum, medium and minimum voltages of the supply bias voltage, the development bias voltage and the collecting bias voltage are the same.

20. The apparatus of claim 17, wherein the maximum, medium and minimum voltages of the supply bias voltage, the development bias voltage and the collecting bias voltage are determined such that a voltage difference of a reverse electric field, of which electric field is oppositely directed in accordance with the supply electric field, a first collection field, and a second collection field, is less than a threshold electric potential difference, at which the toner is transferred, in the supply area and the first and second collecting areas.
